(19) United States
(12) Patent Application Publication
(10) Pub. No.: US 2005/0173561 A1
(43) Pub. Date: Aug. 11, 2005

(54) Spray nozzle assembly

(76) Inventors: John Cotter, Vancouver (CA); David Elvidge, North Vancouver (CA)

Correspondence Address: BRINKS HOFER GILSON & LIONE, P.O. BOX 10395, CHICAGO, IL, 60610, US

(21) Appl. No.: 10/514,384

(22) PCT Filed: May 27, 2003
(86) PCT No.: PCT/CA03/00765

Related U.S. Application Data
(60) Provisional application No. 60/383,739, filed on May 28, 2002.

(51) Int. Cl. B05B 1/28; B05B 7/04; F23D 11/40; F23D 14/62; A62C 5/00

(52) U.S. Cl. 239/398; 239/419.5; 239/290

(57) ABSTRACT

A spray nozzle comprising a nozzle body (110) having an air channel in fluid communication with an air supply, and directing air to one or more air openings (160) at an end of the nozzle body, and a liquid channel in fluid communication with a liquid supply and directing a liquid to a liquid outlet (150) of the nozzle body. An air cap (120) is disposed at the end of the nozzle body and has an orifice in fluid communication with the one or more than one air openings, the orifice is disposed about the outside of the liquid outlet. The spray nozzle also comprises an extension (170) placed on the liquid outlet, outlet protrudes beyond the surface of the air cap. The spray nozzle is well suited for use under windy conditions in that fouling of the nozzle is reduced or eliminated.

### FIELD OF THE INVENTION

The present invention relates to an externally atomizing spray nozzle assembly. More particularly, the present invention relates to an externally atomizing spray nozzle assembly for dispensing liquids.

### BACKGROUND OF THE INVENTION

The dispensing of liquids using a spray nozzle under windy conditions can result in fouling and poor performance of the spray nozzle assembly resulting in repeated down-time of equipment for cleaning. This is especially true when polymeric or particulate-containing liquids or liquids comprising components that may agglomerate are sprayed under windy conditions such as those found within aircraft-based spray practices spraying herbicides, pesticides or fertilizers, spraying of volatile paints in well ventilated environments such as in automotive assembly lines, traffic paint spraying or dispensing of liquid compositions onto a track from a train.

Water-based friction modifiers from onboard a locomotive to the top of a rail requires the use of a nozzle having a design that ensures that the product is applied consistently & reliably. In order to be a commercially feasible system, the dispensing nozzle must be fully functioning between maintenance periods that can range between 90 and 180 days. Unlike onboard dispensing systems that tout a liquid stream as a means of dispensing a lubricant to the top of a rail, an atomized form is preferred when a water-based friction modifier is used, as it permits the entire width of the rail to be covered, is applicable to a wide range of curves, and leads to faster drying rates.

However, with an atomized spray, environmental & physical conditions can adversely affect the spray pattern, which can lead to rapid build-up of the sprayed material on the surface of the nozzle. Environmental conditions include cross flow conditions, for example, the impact of entrained wind currents caused by the moving locomotive. The physical design of the nozzle can also impact on the airflow by creating air turbulence or regions of negative pressure, which can cause the atomized spray to circulate back to the nozzle where it is subsequently deposited. Such a build-up of material on the surface of the nozzle can impede the flow of atomizing air from the nozzle, and reduce the flow of product from the nozzle liquid orifice.

Standard air atomization nozzles use air caps having a pair of diametrically opposed air horns disposed at an acute angle (e.g. 45°), relative to the top surface of the air cap to flatten out a fluid stream emitted from the center of the cap. These air horns tend to clog due to overspray, especially in the presence of external air currents. Such clogging causes an imbalance in the air pressure at the front face of the nozzle, which results in a misdirected, partially atomized fluid stream.

U.S. Pat. No. 2,587,993 describes an externally mixing, air atomization spray nozzle having a circular liquid orifice centrally disposed in the nozzle, an air outlet concentrically disposed and outside the liquid outlet, and two pairs of diametrically opposed air outlets, each pair equally spaced from and outside of the air outlet. One of the pairs of the air outlets directing air flow inwardly of the air cap, and the other pair directing air flow substantially parallel with the air flow from emerging from the center of the cap. This spray nozzle produces a flat, fan-shaped spray pattern, surrounded by an air envelope. The air envelope limits the amount of over spray of the liquid.

U.S. Pat. No. 4,236,674 describes an externally mixing, air atomizing liquid spray nozzle having an elliptical liquid outlet, and an elliptical air outlet concentrically disposed and outside the liquid outlet. This nozzle design directly atomizes the liquid emitted from the spray nozzle into a flat, fan-shaped spray pattern, without the need of additional air horns to flatten out the atomised liquid spray emitted from the center of the nozzle.

It is an object of the invention to overcome disadvantages of the prior art.

The above object is met by the combinations of features of the main claims, the sub-claims disclose further advantageous embodiments of the invention.

### SUMMARY OF THE INVENTION

The present invention relates to an externally atomizing spray nozzle assembly. More particularly, the present invention relates to an externally atomizing spray nozzle assembly for dispensing liquids.

According to one aspect of the present invention, there is provided a spray nozzle comprising:

a body having:
at least one air channel in fluid communication with an air supply, the at least one air channel being adapted to direct air to at least one air opening at a downstream end of the nozzle body; and
a liquid channel in fluid communication with a liquid supply, the liquid channel being adapted to direct a liquid to a liquid opening at a downstream end of the nozzle body;

an air cap disposed at the downstream end of the nozzle body, the air cap having an orifice in fluid communication with the liquid opening and the at least one air opening, the orifice disposed about the outside of the liquid opening, the air cap optionally having no air horns; and

an extension placed on the liquid outlet, so that the liquid outlet protrudes beyond an outside face surface of the air cap.

In this aspect, the orifice directs a flow of compressed air in a forward direction that is substantially parallel to a direction of flow of liquid emitted from the liquid opening to result in at least partial atomization of the liquid.

In an alternate embodiment, the air cap of the spray nozzle of the present invention further comprises a pair of air horns equally spaced from the center of the air cap and located outside of the orifice, each air horn having an air outlet inclined at an angle of 45° with respect to the top surface of the air cap.

The nozzle of the present invention may further comprise an air purge cap for placement around the air cap, the air purge cap having an opening disposed about the outside of the air cap, wherein, the nozzle body further comprises one or more than one ports in fluid communication with the air channel, the one, or more than one ports for directing a portion of the air from the air supply to an air conduit in fluid communication with the opening of the purge shroud. The air diverted to the air conduit is emitted through the opening of the air purge cap toward the center of the air cap, wherein the velocity of the air emitted from the opening is preferably lower than the velocity of the air emitted from the orifice.

In another embodiment, the spray nozzle of the present invention further comprises an air purge cap (shroud) placed around the air cap, the air purge shroud having an opening disposed about the orifice of the air cap, the air purge cap directing air from a second air supply to an air conduit in fluid communication with the opening of the purge shroud.

The present invention also provides a spray nozzle comprising: body having:
at least one air channel in fluid communication with an air supply, the at least one air channel being adapted to direct air to at least one air opening at a downstream end of the nozzle body; and
a liquid channel in fluid communication with a liquid supply, the liquid channel being adapted to direct a liquid to a liquid opening at a downstream end of the nozzle body; and

an air cap disposed at the downstream end of the nozzle body in fluid communication with the liquid opening and the at least one air opening, and having an orifice disposed about the outside of the liquid opening;

an air purge cap disposed around the air cap, the air purge cap having an opening disposed about the outside of the air cap,

an extension placed on the liquid outlet, so that the liquid outlet protrudes beyond an outside face surface of the air cap,

wherein, the nozzle body further comprising one or more than one ports in fluid communication with the air channel, the one, or more than one ports for directing a portion of the air from the air supply to an air conduit in fluid communication with the opening of the purge shroud.

In this aspect of the present invention as just defined, the orifice directs a flow of compressed air in a forward direction that is substantially parallel to a direction of flow of liquid emitted from the liquid opening to result in at least partial atomization of the liquid, and wherein the air purge cap diverts some of the air from the at least one air channel to emit air through the opening and toward the center of the air cap, the air emitted from the opening being preferably of a lower pressure than the air emitted from the orifice. The air purge shroud directs air, preferably, exclusively, from a second air supply to an air conduit in fluid communication with the opening of the purge shroud.

In an alternate embodiment of the invention, the orifice of the air cap is circular, and is preferably concentrically disposed about the outside of the liquid opening.

In another embodiment of the invention, the opening of the air purge cap is circular, and is preferably concentrically disposed about the outside of the air cap.

Alternatively the air cap further comprises a plurality of orifices, which are preferably arc-shaped, positioned in a circular arrangement, the plurality of orifices in fluid communication with the at least one air opening, the arrangement disposed about the outside of the orifice of the air cap.

When the air cap comprises the above-described plurality of orifices, then the orifice of the air cap is preferably in fluid communication with only the liquid opening so that no air is emitted from the orifice of the air cap.

In another embodiment, the extension is a duckbill valve.

In another embodiment the extended portion of the liquid opening is tapered at its end.

In another embodiment, the nozzle of the present invention is enclosed within a housing that has a port for allowing the atomized liquid produced by the nozzle to be emitted outside of the housing.

In another embodiment, the housing comprises a sealing means, for example, an O-ring, for forming a seal between the nozzle and the port of the housing.

The nozzle of the present invention produces an annular air flow from the central orifice that is substantially parallel to the flow of a liquid material emitted from the spray nozzle. This type of air flow results in an atomized material that has a larger drop size than that produced using a spray nozzle having a pair of oppositely disposed spray horns, which are equally spaced from the center orifice of the air cap. The larger drop size of the atomized material produced according to the present invention results in a narrower spray pattern, with a significantly reduced amount of overspray and buildup on the spray nozzle and cap.

### BRIEF DESCRIPTION OF THE DRAWINGS

These and other features of the invention will become more apparent from the following description in which reference is made to the appended drawings wherein:

FIGS. 1A and 1B show sections of side elevational views of examples of prior art spray nozzle assemblies.

FIGS. 2A and 2B show sections of side elevational views of examples of embodiments of the spray nozzle assembly of the present invention.

FIG. 2C shows a front view of an air cap (air purge cap) used with an example of an embodiment of the spray nozzle assembly of the present invention.

FIG. 3 shows a section of a side elevational view of an alternate example of an embodiment of the spray nozzle assembly of the present invention, which includes an air purge cap.

FIG. 4 shows an front view of the of the nozzle assembly of FIG. 3, in the direction of arrows 4-4.

FIG. 5A shows a section of a side elevational view of an example of an embodiment of the present invention, in which the nozzle assembly shown in FIG. 3 is partially enclosed within a rectangular housing.

FIG. 5B shows a bottom plan view of the example of FIG. 5A.

FIGS. 6A-B show pictures of the air cap portion of the spray nozzle assembly of FIG. 1A, partially enclosed within a rectangular housing, before and after 6.5 hours of spraying KELTRACK™ (a friction modifier composition) in the presence of a 30-31 km/hr. wind.

FIGS. 7A-B show pictures of the air cap portion of the spray nozzle assembly of FIGS. 3 and 4, partially enclosed within a rectangular housing, before and after 8 hours of spraying KELTRACK™ (a friction modifier composition) in the presence of a 30 km/hr. wind.

FIG. 8 shows an example of an alternate housing for the spray nozzle assembly.

### DESCRIPTION OF PREFERRED EMBODIMENT

The present invention relates to an externally atomizing spray nozzle assembly. More particularly, the present invention relates to an externally atomizing spray nozzle assembly for dispensing liquids, for example but not limited to friction modifiers or lubricants.

The following description is of a preferred embodiment by way of example only and without limitation to the combination of features necessary for carrying the invention into effect.

The spray nozzle assembly of the present invention is suited for atomising viscous liquids, or liquids comprising particulates, for example but not limited to liquid friction control compositions to be applied to the top of a rail of railway track. Non-limiting examples of such liquid friction control compositions include KELTRACK™ and those disclosed in WO 98/13445, WO 02/26919, CA 2,321,507, or EP 02252651 (which are incorporated herein by reference). However, it is to be understood that any liquid may be dispensed using the spray nozzle assembly as described herein.

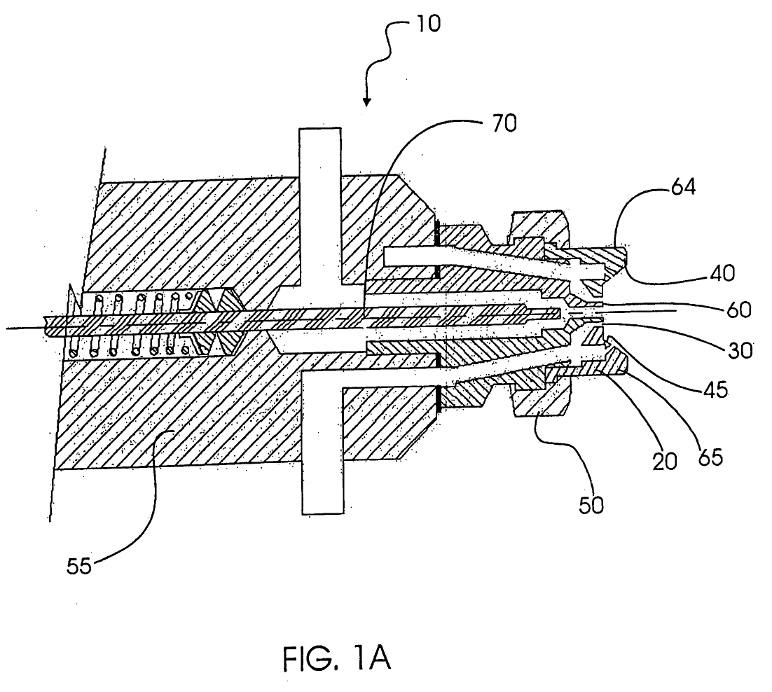

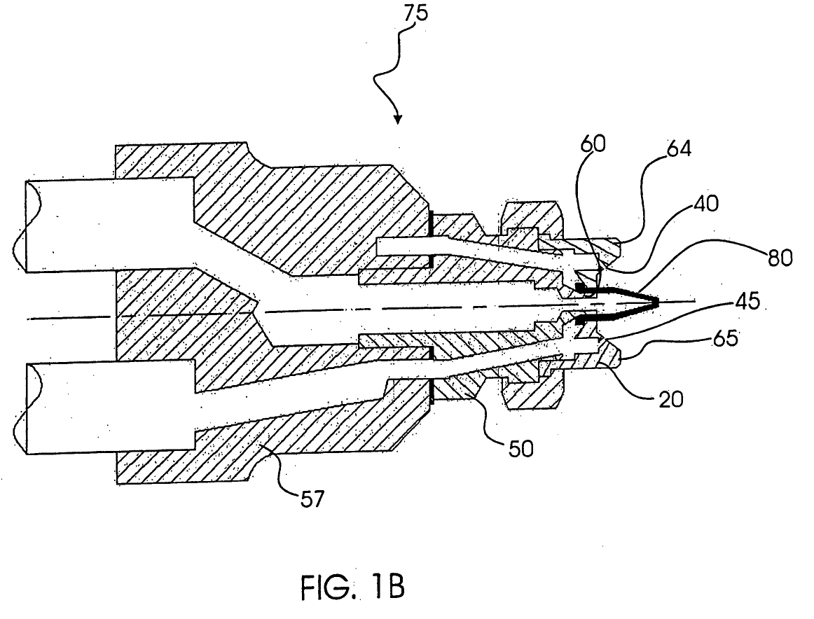

The inventors have observed that existing spray nozzles (as shown in FIGS. 1A and B) are not suitable for delivery of viscous fluids, or fluids comprising particulates under windy conditions due to fouling of the spray nozzle. Windy conditions tend increase the rate of deposition of the atomized liquid on the spray nozzle. This problem is exasperated under conditions of continuous wind, for example those encountered during application of liquid friction control compositions to railway tracks from a moving Hi-Rail truck or on board a train. However, other conditions that produce cross flow air current may also lead to fouling of a spray nozzle. Fouling of spray nozzles may also occur within different spray applications, for example but not limited to aircraft-based spraying of fertilizers, pesticides or herbicides, traffic line spraying, or paint spraying under well ventilated conditions within assembly lines, and the nozzle assembly of this invention may be suited for these uses as well.

The spray nozzle assembly as described herein is also suited for dispensing an atomized spray under conditions with cross flow air currents that would otherwise result in the fouling of the spray nozzle from over spray. The spray nozzles of the present invention reduce or eliminate fouling when used under conditions having cross flow air currents. Without wishing to be bound by theory, the spray nozzles of the present invention reduce fouling of the nozzle by:

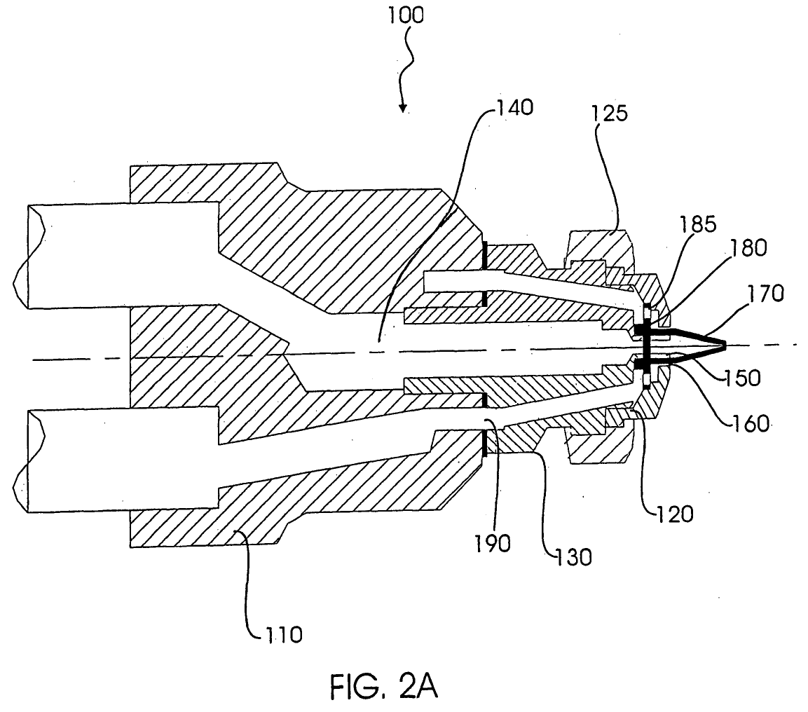

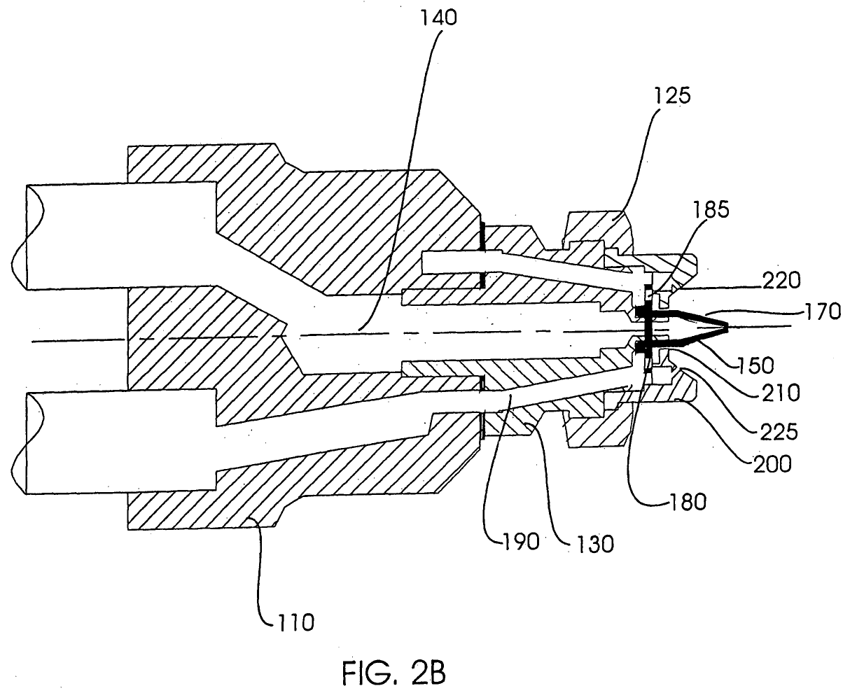

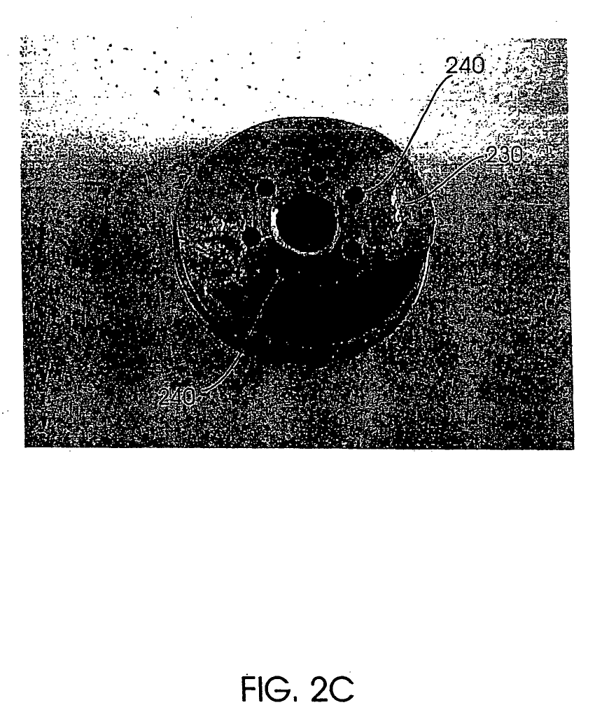

i) reducing the fanning of the atomized spray emerging from the spray nozzle, for example by either reducing or removing point sources of laterally supplied air to the spray nozzle, for example, the lateral air supply delivered through the air horns (e.g. 65, FIGS. 1A and 1B), or by removing the air horns, and associate air supply from the spray nozzle (e.g. FIG. 2A);

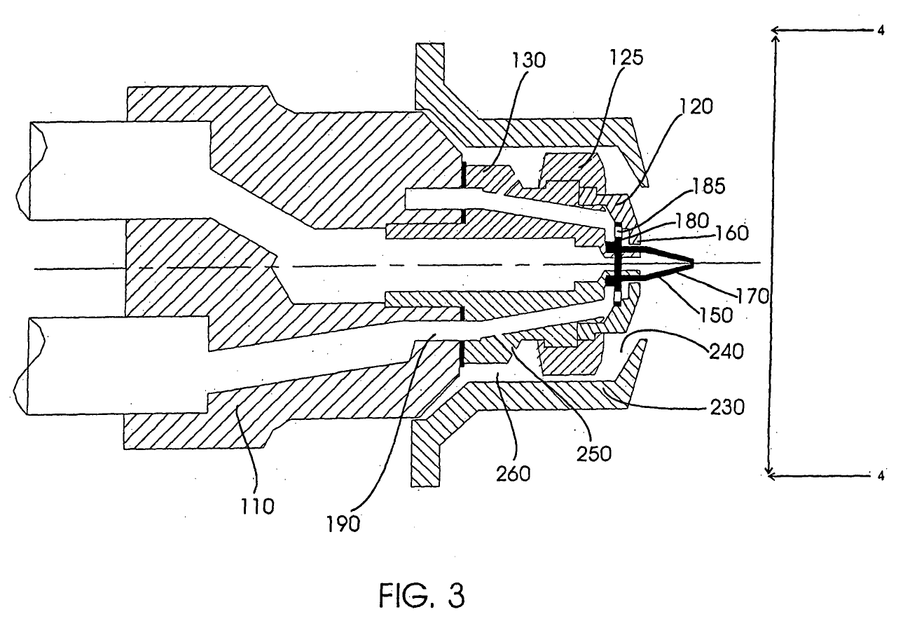

ii) creating a positive pressure microenvironment at the front face of the spray nozzle, thereby increasing the velocity of air flow over the surface of the nozzle face to reduce or eliminate deposition of spray droplets on the nozzle face. Preferably the positive pressure microenvironment is uniform with respect to the atomized spray, in that this positive pressure microenvironment does not produce an asymmetrical over spray. The increase in the positive pressure microenvironment of the spray nozzle may be obtained by, for example, which is not to be considered limiting in any manner, supplying an air stream via a purge shroud (also referred to as an air purge cap; e.g. FIG. 2C, and 230, FIG. 3);

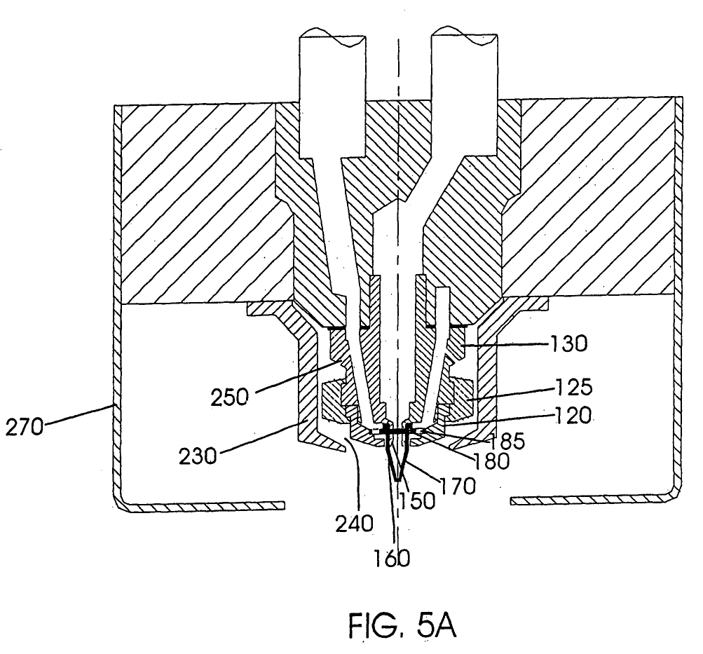

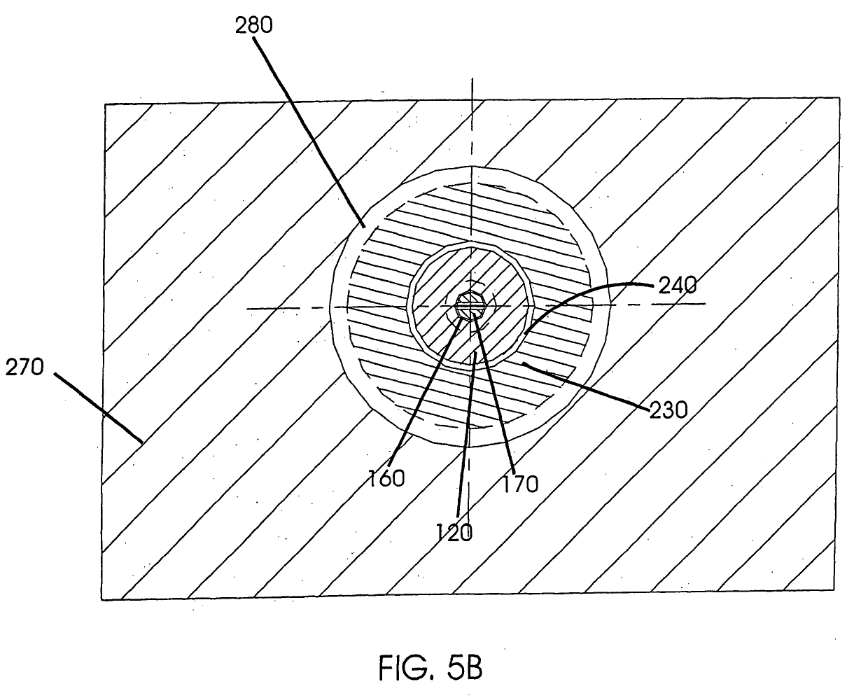

iii) increasing the flow of air that is coaxial with the atomized spray, relative to any lateral air flow. This may be done using any suitable means, for example, but not limited to either:
a) extending the liquid outlet (150, FIGS. 2A and 2B) of the spray nozzle beyond the front outside surface of air cap 120 or 200;
b) adding a duckbill (e.g. 170, FIGS. 2A, 2B, 3 and 4) to the spray outlet; or
c) adding a housing that surrounds a portion of the spray nozzle to reduce or remove external air currents from around the spray nozzle (FIGS. 5A and 5B);

iv) or, a combination of the above.

Referring to FIG. 1A, there is shown a spray nozzle assembly (10) using prior art air cap 20, liquid cap 50, and side-loading nozzle body 55. Air cap 20 has both a centrally-located circular orifice 30 and a pair of equally-spaced air outlets 40 and 45, inclined at an angle of 45°. Liquid emitted from liquid aperture 60 is atomized by the annular flow of air emitted from circular orifice 30. The atomized spray is then flattened or fanned out by the air flow directed from the air outlets 40 and 45 in air horns 64 and 65. An air-actuated needle valve 70 is used to open and close liquid aperture 60.

FIG. 1B shows a rear-loading spray nozzle assembly (75), using the liquid cap and air cap of the nozzle assembly illustrated in FIG. 1A, and replacing the needle valve with a flexible duckbill 80, as is known in the art. The duckbill may be made of rubber or other flexible material. The base of duckbill 80 is secured between air cap 20 and liquid cap 50, and extends axially beyond the top face of air cap 20. As the front end of duckbill 80 occupies the entire area of air orifice 30, only liquid is emitted from the center of air cap 20. When used in windy conditions, or in situations where there are strong air currents generated, for example, by ventilation systems, the air outlets and/or liquid outlet of both of the spray nozzle assemblies shown in FIGS. 1A and 1B become easily coated due to overspray of the atomized liquid, resulting in increasingly degraded spray performance over time.

Referring to FIG. 2A, there is shown a non-limiting example of a spray nozzle assembly (100) of the present invention including a nozzle body 110, an air cap 120, and a liquid cap 130. A fastening nut 125 is used to secure air cap 120 to liquid cap 130. The liquid cap 130, may be integral with the nozzle body 110. Nozzle body (110) comprises a more or less centrally disposed longitudinally extending channel 140 for carrying the liquid. The liquid is directed to liquid outlet 150, which is in fluid communication with a circular orifice 160 in air cap 120. The base of a flexible rubber duckbill 170 is secured between air cap 120 and liquid cap 130. A retaining ring 180 having air holes 185 evenly distributed about its perimeter is positioned between the base of the duckbill 170 and air cap 120 to secure the duckbill in position.

Air channel 190 provides compressed air in fluid communication with circular orifice 160. Movement of a liquid from liquid chamber 140 by the use of a pump results in a flow of a liquid through liquid outlet 150 and through duckbill 170. Compressed air moving through air channels 190 passes through holes 185 in retaining ring 180, and then through circular orifice 160 producing a uniform, circular, coaxial air flow, and atomizes the liquid emerging from the liquid outlet 150 to produce an atomized spray.

In the non-limiting example shown in FIG. 2A, the uniform, circular, coaxial air flow that emerges from circular orifice 160, produces a spray pattern with reduced overspray thereby reducing fouling of the nozzle. Also the coaxial air flow helps to maintain the region surrounding the liquid outlet 150 free of deposited atomized liquid.

An alternate non-limiting example of the present invention is shown in FIG. 2B, where the air cap of the spray nozzle assembly depicted in FIG. 2A is replaced with air cap 200 having both a centrally-located circular orifice 210 and a pair of air outlets (220, 225) equally spaced from the center of the air cap, and inclined at an angle of 45° with respect to the top surface of the cap. The air emitted from the air outlets 220 and 225 causes fanning of the atomized spray produced from the center of air cap 200.

In another aspect of the present invention, the length of the liquid outlet 150 is extended beyond the front face of the air cap (120, 200), and may be tapered at its tip. In this example, the duckbill may be also be used to further extend the extended portion of the liquid outlet, be replaced by an air- or mechanically actuated needle valve, or used together with a needle valve.

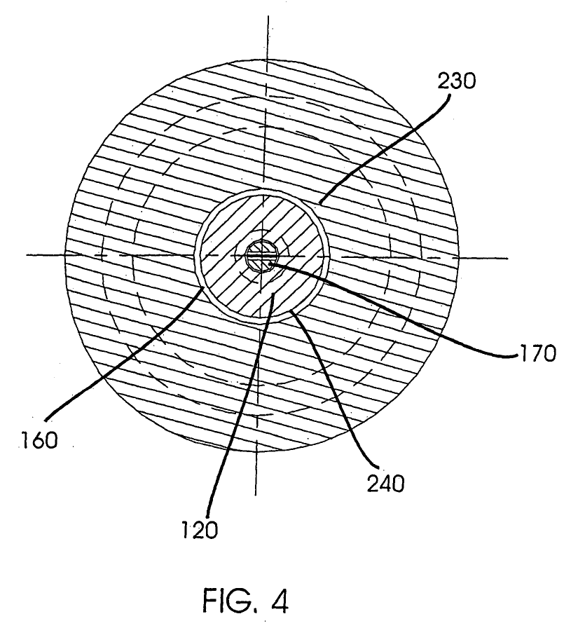

In an additional example of the present invention illustrated in FIGS. 3 and 4, the spray nozzle shown in FIG. 2A includes an air purge cap (or shroud) 230 located about air cap 120. Air purge cap 230 has one (e.g. FIG. 4) or more than one (e.g. see FIG. 2C) purge openings 240 concentrically disposed about the outside of air cap 120. Air channel 190 may be adapted to divert compressed air via one, or more than one, port 250 located within liquid cap (130) to air conduit 260 formed between liquid cap 130, air cap 120, and air purge cap 230 so that air is released through one, or more than one, purge opening 240. The size of port 250 may be adjusted to regulate the pressure and volume of compressed air flowing out through purge opening 240. For example, which is not meant to be considered limiting in any manner, use of 2 ports (250) each of about 1.27 mm (0.05 inch) dia, and placed 180° apart, 3 ports (250), each of about 0.794 mm (0.03125 inch) dia. and spaced equidistantly, about 120° apart around the liquid cap (130), or 5 ports (250), each of about 0.889 mm (0.035 inch) dia. and spaced 72° apart, may be sufficient to deliver airflow through the purge opening (240). However, additional ports (250), having alternated opening diameters may be used as required.

The purge opening may comprise an annular continuous ring opening to provide a uniform stream of air around the coaxial air flow provided through circular orifice 160, for example as shown in FIG. 4, however, a plurality of openings may also be employed to provide a positive pressure environment at the front face of the spray nozzle (see FIG. 2C). For example, which is not to be considered limiting in any manner, several partial annular ring openings, or semi-circular openings may be used, or a plurality of either round or circular openings may be disposed in a concentric manner in purge shroud 230, around circular orifice 160. The clearance of the purge opening (240) between the corner of the air cap (120) and the inner edge of the purge air cap (230) should be chosen so that the velocity of the emitted air effectively prevents the deposition of material on the circular orifice 160, but at the same time does not interfere with the direction of flow of the resulting atomized spray and result in overspray. The width of the clearance can be determined by routine experimentation without the necessity of inventive ingenuity. Non-limiting examples of the width of the purge opening 240 include from about 0.254 mm to about 5.08 mm (about 0.010 inch to about 0.2 inch), from about 1.27 mm to about 3.81 mm (0.05 inch to about 0.15 inch), about 1.54 mm to about 2.54 mm (about 0.06 inch, or about 0.1 inch), about 2.54 mm (0.1 inch), or about 1.6 mm (0.063 inch).

In an alternative embodiment, air conduit 260 is supplied by an independent source of pressurized air, so that the velocity and/or pressure of air emitted from purge opening 240 can be independently controlled.

The air released from purge opening 240 produces a positive pressure microenvironment at the front face of the spray nozzle. Any suitable air pressure may be used that ensures reduced fouling arising from over spray. Preferably, the velocity and volume of air emerging from purge opening 240 is less than that emerging from circular orifice 160. More preferably, the velocity of the air emerging from purge opening 240 is about 0.05 to about 90%, more preferably about 0.1 to about 50% of the velocity of the air that is released through circular orifice 160.

In another aspect of the present invention, the air emitted from purge opening 240 is emitted at an angle of from about 0 to about 90°, more preferably about 0 to about 45°, with respect to the top face of air cap 120.

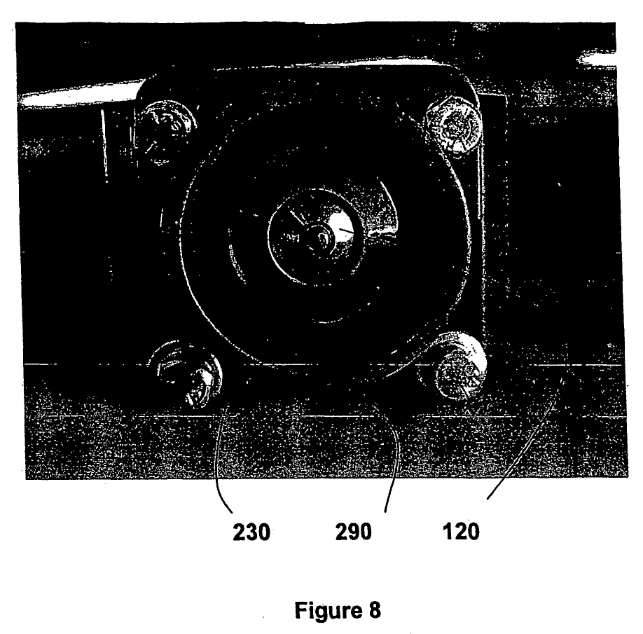

FIGS. 5A, 5B and 8, show non-limiting examples of housings that the spray nozzle assembly illustrated in FIG. 2A may be attached to when in use in the field. In these examples, which are not to be considered limiting in any manner, the housing may be configured as a nozzle cover (270, FIGS. 5A and B) or as a recessed housing (290, FIG. 8). However, other housing configurations may also be contemplated that provide a means for attaching the nozzle while in use in the field, protecting the nozzle components, or both.

With reference to FIGS. 5A and 5B, the nozzle cover (270) may comprise one, or more than one port 280 to permit the spray from the nozzle assembly to exit. Alternatively, a recessed housing (290; FIG. 8) may be used to provide ready access to nozzle components in the filed, yet due to the recess within the housing, provide protection to the nozzle components.

The housing may be separate from the nozzle assembly, or the housing may be attached to the nozzle assembly for example, but not limited to, attached to the nozzle body, or the outer circumference of the purge shroud. The housing may help ensure that the nozzle assembly is free from fouling. Even though the housing assists in reducing fouling of the nozzle assembly, the housing may not be required to reduce fouling of the air cap of the nozzle assembly.

The housing (270, FIGS. 5A and 5B; or 290, FIG. 8) also protects the nozzle assembly from grease, salt, ice-buildup, foreign debris and rocks during use. The housing (270; 290) is therefore preferably constructed of a strong, resilient material that is resistant to corrosion. In the case of a nozzle cover (270), the housing may be made in the form of a rectangular box or a cylinder, however, any form may be used that can effectively protect the spray nozzle assembly, and that does not impede its continuous operation.

If the housing is a nozzle cover, and if the nozzle cover is not be attached to the nozzle body, a second port may be provided within the nozzle cover to permit introduction of a second air stream within the cover. Preferably, the nozzle cover is sealed to ensure that air flows only past the nozzle port. This second stream creates a positive pressure microenvironment within the nozzle cover thereby ensuring air flow out from the nozzle cover and nozzle, and reducing fouling of the nozzle from over spray. A similar effect is created by attached the nozzle cover to the purge shroud, in that a air stream emerging from the purge shroud.

Testing using a nozzle cover (270; FIGS. 5A and B) demonstrates reduced fouling of the nozzle assembly (see Example 6). Similar testing of the recessed housing (290, FIG. 8) also demonstrates low fouling (spray buildup) of the nozzle assembly (see example 7).

Preferably the nozzle is recessed within the nozzle cover (270) or recessed with the recessed housing (290) so that the outer surface of the nozzle assembly does not protrude from the housing.

Although it is preferred that the material emitted from the liquid nozzle is completely atomized, partially atomized material is within the scope of the present invention.

The spray nozzle of the present invention is especially useful for spraying liquid material that is viscous, but may be used for any type of material, present in any form. The spray nozzle of the present invention is particularly suited for use in conditions where the material is to be applied in a windy environment.

Although the spray nozzle assemblies of the present invention have been particularly described for use in applying viscous friction control compositions to railway tracks, these spray nozzles are equally effective in applying any type of composition in an environment in which there are strong air currents. Examples of such alternate spray applications include, but are not limited to spraying of crops with pesticides, traffic line spraying, and spray coating of automobiles in strongly ventilated environments.

The above description is not intended to limit the claimed invention in any manner, furthermore, the discussed combination of features might not be absolutely necessary for the inventive solution.

The present invention will be further illustrated in the following examples. However it is to be understood that these examples are for illustrative purposes only, and should not be used to limit the scope of the present invention in any manner.

### EXAMPLE 1 (COMPARATIVE)

Spray Test Using a Spray Nozzle Having Separate Atomizing and Fanning Air Flows and Using a Needle Valve.

This test employed a spray nozzle assembly consisting of a spray body (Model 1/4 JAU), a fluid cap (Model 60100), and an air cap having a centrally-located circular orifice and a pair of oppositely disposed air horns (Model 67228-45), all supplied by Industrial Spray Products (Wheaton, Ill.). Each air horn was equally spaced from the center of the cap and inclined at an angle of 45° with respect to the top surface of the cap. The circular orifice of the air cap was bored out to a diameter of 0.125″ (0.3 cm). The spray nozzle assembly is shown in FIG. 1A. When in use, the air cap of the spray nozzle produced both an atomizing air flow from its centrally-located circular orifice and a fanning air flow from the air horns. An air-actuated needle valve, positioned within the liquid chamber of the liquid cap, was used to turn on or turn off the flow of liquid emitted through the liquid cap. The spray nozzle was encased in a nozzle cover (3.91 in.×2.74 in.×2.63 in.) having a circular opening with a diameter of 1.5 in. approximately centrally disposed at its bottom end. The flat portion of the air cap of the spray nozzle assembly was positioned 9 mm above the opening of the nozzle cover.

The spray nozzle assembly was placed in a wind tunnel (2 ft×2 ft×6 ft) behind a mock locomotive wheel (36 inch diameter). An electrical blower (Dry Eaze, Model F174, 5000 CFM) was used to supply an air flow of 30-31 km/hr. past the locomotive wheel. An friction modifier composition (KELTRACK™, Kelsan Technologies Corp.) was supplied through the nozzle body and emitted from the center of the air cap at a spray rate of 0.1 L/mile at a train speed of 30 km/hr. An anemometer instrument (Fisher Scientific) was used to measure the air speed traveling past the wheel and spray assembly during the test.

The spray nozzle and cover were positioned approximately 22 inches behind the center of the wheel (in the direction of the wind) with the bottom of the nozzle cover 4 in. above the surface of the floor. Air was supplied through the centrally-located air orifice and the pair of air horns at an air pressure of 20 psi. The test was run for a period of 6.5 hr.

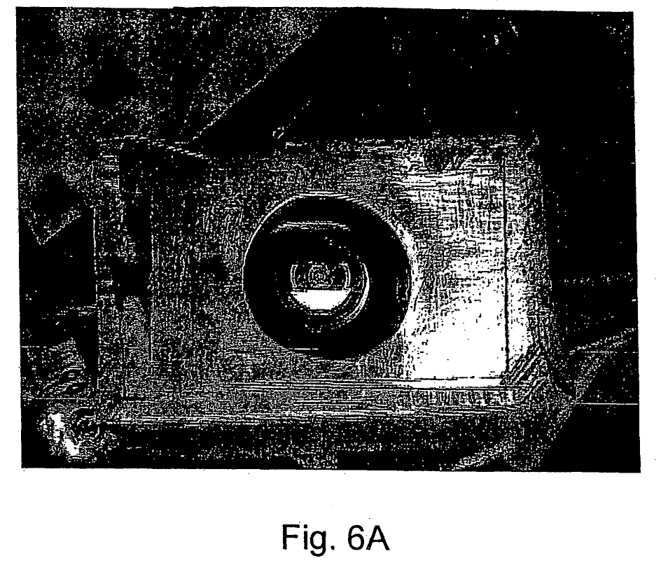

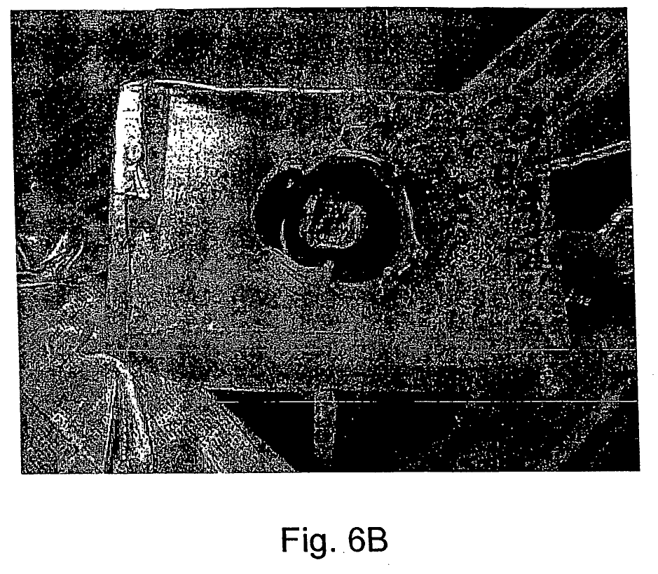

Buildup on the nozzle cover and the spray nozzle was seen early on in the test and continued, resulting in deterioration of the spray uniformity and direction. Build up was great enough to entirely block off the air flow from the air horns and most of the atomizing air flow from the center of the air cap (FIGS. 6A-B). Large amounts of spray buildup were also seen in the inside surfaces of the nozzle cover body.

### EXAMPLE 2 (COMPARATIVE)

Spray test using a spray nozzle having only a fanning air flow and using a duckbill valve.

This test employed a spray nozzle assembly consisting of a spray body (Model 1/4 JBC), a fluid cap (Model 60100), and an air cap having a centrally-located circular orifice and a pair of oppositely disposed air horns (Model 67228-45), all supplied by Industrial Spray Products (Wheaton, Ill.). Each air horn was equally spaced from the center of the cap and inclined at an angle of 45° with respect to the top surface of the cap. The circular orifice of the air cap was bored out to a diameter of 0.153″. A flexible rubber duckbill (supplied from Lubriquip Inc., Cleveland, Ohio) was attached to the liquid outlet of the fluid cap. The base of the duckbill was secured between the air cap and the liquid cap. The front end of the duckbill protruded out of the centrally-located circular orifice of the air cap and occupied the entire area of the orifice, so that only liquid could be emitted from the center of the air cap. The spray nozzle assembly is shown in FIG. 1B.

The test was run as described in Example 1, with the following modifications: the test was run for 8 hours using a spray application of 0.1 L/mile, at a train speed of 30 km/hr., a wind speed of 30 km/hr., and an air pressure setting of 40 psi. After the test was complete, there was product buildup seen on the trailing edge (in the direction away from the wind source) of the spray nozzle and outside of the spray nozzle cover. Spray buildup encompassed 100% of the spray cap and nozzle, and was also observed on the outer surface of the retaining nuts.

### EXAMPLE 3

Spray test using a spray nozzle having only an annular atomizing air flow.

This test employed spray nozzle assembly, nozzle cover and wind tunnel set-up of Example 2, except that the air cap was replaced with one having only a centrally-located circular orifice having a diameter of 0.173″. The base of the duckbill was secured between the air cap and the liquid cap. A retaining ring having four air holes evenly distributed about its perimeter was positioned between the base of the duckbill and the air cap to secure the duckbill in position. The holes in the retaining ring permitted air to pass through to the circular orifice of the air cap. The front end of the duckbill protruded out of the centrally-located circular orifice of the air cap and an annular orifice (0.25 wide) formed around the periphery of the duckbill. The air flow emitted through the annular opening was substantially parallel to the flow of liquid emitted from the duckbill. The spray nozzle assembly is shown in FIG. 2A.

The test was run for ½ hour using a spray rate of 0.1 L/mile at a train speed of 30 km/hr., in a wind speed of 30 km/hr, and an air pressure setting of 40 psi. After this test was completed, there was no appreciable buildup seen on the spray nozzle or on the outside of the spray nozzle cover.

### EXAMPLE 4

Spray Test Using a Spray Nozzle Having Separate Atomizing and Fanning Air Flows and Using a Duckbill Valve.

This test employed spray nozzle assembly, nozzle cover and wind tunnel set-up of Example 2, except that that the centrally located circular orifice of the air cap was enlarged to a diameter of 4.39 mm (0.173 inch). The front end of the duckbill protruded out of the centrally-located circular orifice of the air cap and an annular orifice (0.25 mm wide) formed around the periphery of the duckbill. The air flow emitted through the annular opening was substantially parallel to the flow of liquid emitted from the duckbill. The spray nozzle assembly is shown in FIG. 2B.

The test was run for 8 hour using a spray rate of 0.1 L/mile at a train speed of 30 km/hr. in a wind speed of 30 km/hr, and an air pressure setting of 40 psi. After this test was completed, coverage of the air cap was about 20-30% of the amount of coverage observed from the results of Example 2, and the trailing side of the nozzle cover had a similar area of deposition, but only 30% as thick as the thickness observed from the results of Example 2.

### EXAMPLE 5

Spray Test Using a Spray Nozzle Providing an Atomizing Air Flow From Six Evenly Spaced Circular Openings.

This test employed the spray nozzle assembly, nozzle cover and wind tunnel set-up of Example 2, except that the air cap was replaced with a cap having six circular openings (each having a diameter of 3/64″) provided in a circular arrangement, concentric with a centrally-located circular orifice having a diameter of 3.89 mm (0.153 inch). The center of each circular opening was 3.5 mm from the center of the air cap. The base of the duckbill was secured between the air cap and the liquid cap. The front end of the duckbill protruded out of the centrally-located circular orifice of the air cap and occupied the entire area of the orifice, so that only liquid could be emitted from the center of the air cap. The air cap of the spray nozzle assembly is shown in FIG. 2C. Each of the circular openings provided an air flow that was substantially parallel to the flow of liquid emitted from the duckbill.

The test was run for ½ hour using a spray rate of 0.1 L/mile at a train speed of 30 km/hr. in a wind speed of 30 km/hr, and an air pressure setting of 40 psi. After this test was completed, there was no appreciable buildup seen on the spray nozzle, and a minimal amount on the outside of the spray nozzle cover.

### EXAMPLE 6

Spray Test Using a Spray Nozzle Having Both an Annular Atomizing Air Flow, and a Purging Air Flow.

This test employed the spray nozzle assembly of Example 3, and the nozzle cover and wind tunnel set-up of Example 4. In addition, the spray nozzle included an air purge cap having a circular aperture (diameter=17.5 mm), which was secured around the liquid cap (FIG. 3). An annular aperture 1.6 mm wide was formed between the outer edge of the air cap and a flange formed on the outside face of the air purge cap. The liquid cap was modified to add ports for feeding pressurized air from its air channels to an air conduit formed between the liquid cap and the air purge cap. The air in the air conduit was directed through the annular aperture inwardly across the face of the air cap.

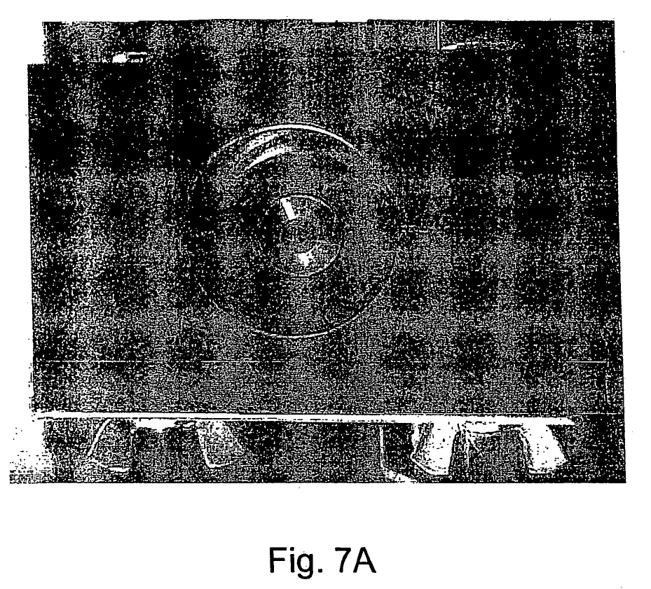

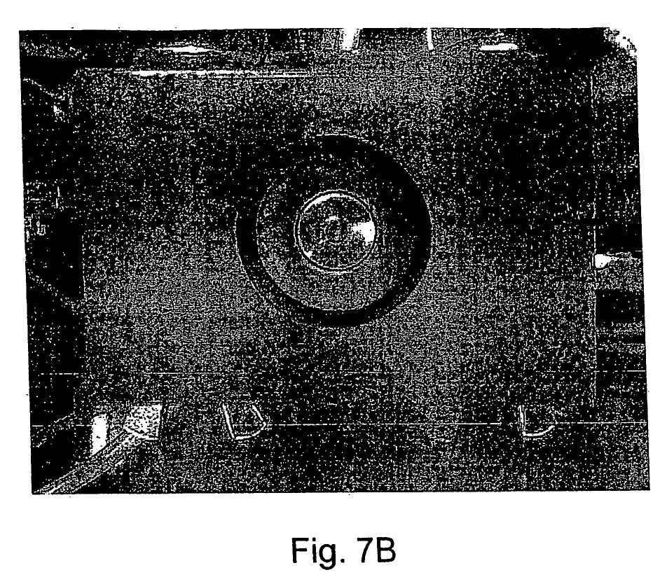

The test was run for 8 hours using a spray application of 0.1 L/mile at a train speed of 30 km/hr, in a wind speed of 30 km/hr, and an air pressure setting=40 psi. After this test was completed, coverage of the air cap was about 10-15% of the amount of coverage observed from the results of Example 1 (FIGS. 7A-B). A similar area of buildup was observed on the outside of the nozzle cover to that seen from the results of Example 4, however, the thickness of the layer was reduced by 50% of that observed in Example 4.

### EXAMPLE 7

Spray Test Using a Spray Nozzle Having Both an Annular Atomizing Air Flow, and a Purging Air Flow With a Modified Design.

This test employed the spray nozzle assembly of Example 3, and the nozzle cover and wind tunnel set-up of Example 4. In addition, the spray nozzle included an air purge cap having a circular aperture (diameter=17.5 mm), which was secured around the liquid cap (FIG. 3). An annular aperture 1.6 mm (0.063 inch) wide was formed between the outer edge of the air cap and a flange formed on the outside face of the air purge cap. The liquid cap was modified to add 5 ports each of 0.889 mm (0.035 inch) dia. and spaced 72° apart for feeding pressurized air from its air channels to an air conduit formed between the liquid cap and the air purge cap. The air in the air conduit was directed through the annular aperture inwardly across the face of the air cap.

The test was run as outlined in Example 6, with an addition test parameter so that the spray nozzle assembly was subjected to accelerated vibration testing over a range of temperatures. Reduced nozzle clogging was observed with this nozzle assembly.

The same nozzle assembly was then tested in the field, attached behind a locomotive wheel with a recessed housing (FIG. 8) and used to supply liquid friction control composition to track.

The test nozzle was inspected approximately 1 month after installation. At that time, the nozzle had 36.5 hours of spraying time. The spray nozzle, flexible duckbill and air cap components were free from contamination. After 95 hours of filed testing the surrounding area had a slight partial coating of fluid of negligible thickness, with no indication of buildup, the duckbill looked clean, and the nozzle performed in a manner as initially installed.

All citations are herein incorporated by reference.

The present invention has been described with regard to preferred embodiments. However, it will be obvious to persons skilled in the art that a number of variations and modifications can be made without departing from the scope of the invention as described herein.

1. A spray nozzle comprising:
a nozzle body having
an air channel in fluid communication with an air supply, the air channel directing air to one, or more than one, air openings at a downstream end of the nozzle body; and
a liquid channel in fluid communication with a liquid supply, the liquid channel directing a liquid to a liquid outlet at the downstream end of the nozzle body;
an air cap disposed at the downstream end of the nozzle body, the air cap having an orifice in fluid communication with the one or more than one air openings, the orifice disposed about the outside of the liquid outlet; and
an extension placed on the liquid outlet, so that the liquid outlet protrudes beyond an outside face surface of the air cap.

2. The spray nozzle of claim 1, wherein the air cap further comprises a pair of air horns equally spaced from the center of the air cap and located outside of the orifice, each air horn having an air outlet inclined at an angle of 45° with respect to the top surface of the air cap.

3. The spray nozzle of claim 1, further comprising:
an air purge shroud placed around the air cap, the air purge shroud having an opening disposed about the orifice of the air cap,
wherein, the nozzle body further comprising one or more than one ports in fluid communication with the air channel, the one, or more than one ports for directing a portion of the air from the air supply to an air conduit in fluid communication with the opening of the purge shroud.

4. The spray nozzle of claim 3, wherein the velocity of the air emitted from the opening of the purge shroud is less than the velocity of the air that is emitted from the orifice.

5. The spray nozzle of claim 3, wherein the velocity of the air emitted from the opening of the purge shroud is about 0.05 to about 90% of the velocity of the air that is emitted from the orifice.

6. The spray nozzle of claim 3, wherein the air emitted from the opening of the purge shroud is emitted at an angle of from about 0 to about 90° with respect to the direction of spray of the liquid.

7. The spray nozzle of claim 3, wherein the air emitted from the orifice is emitted at an angle of from 0 to 45° with respect to the direction of spray of the liquid.

8. The spray nozzle of claim 1, further comprising:
an air purge shroud placed around the air cap, the air purge shroud having an opening disposed about the orifice of the air cap,
the air purge cap directing air from a second air supply to an air conduit in fluid communication with the opening of the purge shroud.

9. The spray nozzle of claim 8, wherein the velocity of the air emitted from the opening of the purge shroud is less than the velocity of the air that is emitted from the orifice.

10. The spray nozzle of claim 8, wherein the velocity of the air emitted from the opening of the purge shroud is from about 0.05 to about 90% of the velocity of the air that is emitted from the orifice.

11. The spray nozzle of claim 8, wherein the air emitted from the opening of the purge shroud is emitted at an angle of from about 0 to about 90° with respect to the direction of spray of the liquid.

12. The spray nozzle of claim 8, wherein the air emitted from the orifice is emitted at an angle of from 0 to 45° with respect to the direction of spray of the liquid.

13. The spray nozzle of claim 1, wherein the air cap further comprises a second, or a plurality of second orifices positioned in a circumferential arrangement around the orifice, the second or a plurality of second orifices in fluid communication with the air supply.

14. The spray nozzle of claim 13, wherein the second, or a plurality of second orifices are arc-shaped.

15. The spray nozzle of claim 13, wherein the second, or a plurality of second orifices are round.

16. The spray nozzle of claim 1, wherein the extension is tapered at its end.

17. The spray nozzle of claim 9, wherein the extension is a duckbill valve.

18. The spray nozzle of claim 1, further comprising a valve member for sealing the liquid opening.

19. The spray nozzle of claim 18, wherein the valve member is an air actuatable needle.

20. The spray nozzle of claim 1, which is enclosed within a housing, the housing comprising a port for allowing the atomized liquid to be emitted outside of the housing.

21. The spray nozzle of claim 20, wherein the housing comprises a sealing means for forming a seal between the spray nozzle and the port of the housing.

22. A spray nozzle comprising:
a nozzle body having:
an air channel in fluid communication with an air supply, the air channel directing air to at least one air opening at a downstream end of the nozzle body; and
a liquid channel in fluid communication with a liquid supply, the liquid channel directing a liquid to a liquid outlet at the downstream end of the nozzle body;
a air cap disposed at the downstream end of the nozzle body in fluid communication with the liquid outlet and the air opening, and having an orifice disposed about the outside of the liquid outlet;
an extension placed on the liquid outlet, so that the liquid outlet protrudes beyond an outside face surface of the air cap.
an air purge shroud disposed around the air cap, the air purge shroud having an opening disposed about the orifice of the air cap,
wherein, the nozzle body further comprising one or more than one ports in fluid communication with the air channel, the one, or more than one ports for directing a portion of the air from the air supply to an air conduit in fluid communication with the opening of the purge shroud.

23. The spray nozzle of claim 22, wherein the air purge shroud directs air from a second air supply to an air conduit in fluid communication with the opening of the purge shroud.

24. The spray nozzle of claim 23, wherein the air is directed exclusively from the second air supply.

25. The spray nozzle of claim 22, wherein the velocity of the air emitted from the opening of the purge shroud is less than the velocity of the air that is emitted from the orifice.

26. The spray nozzle of claim 22, wherein the velocity of the air emitted from the opening of the purge shroud is from about 0.05% to about 90% of the velocity of the air that is emitted from the orifice.

27. The spray nozzle of claim 22, wherein the air emitted from the opening of the purge shroud is emitted at an angle of from about 0 to about 90° with respect to the direction of spray of the liquid.

28. The spray nozzle of claim 22, wherein the air emitted from the orifice is emitted at an angle of from 0 to 45° with respect to the direction of spray of the liquid.

29. The spray nozzle of claim 22, wherein the air cap further comprises a second, or a plurality of second orifices positioned in a circumferential arrangement around the orifice, the second or the plurality of second orifices in fluid communication with the air supply.

30. The spray nozzle of claim 29, wherein the second, or the plurality of second orifices are arc-shaped.

31. The spray nozzle of claim 29, wherein the second, or a plurality of second orifices are round.

32. The spray nozzle of claim 22, wherein the extension is tapered at its end.

33. The spray nozzle of claim 22, wherein the extension is a duckbill valve.

34. The spray nozzle of claim 22, further comprising a valve member for sealing the liquid opening.

35. The spray nozzle of claim 34, wherein the valve member is an air actuatable needle.

36. The spray nozzle of claim 22, which is enclosed within a housing, the housing comprising a port for allowing the atomized liquid to be emitted outside of the housing.

37. The spray nozzle of claim 36, wherein the housing comprises a sealing means for forming a seal between the spray nozzle and the port of the housing.
